(19) United States
(12) Patent Application Publication
(10) Pub. No.: US 2024/0002190 A1
(43) Pub. Date: Jan. 4, 2024

(54) METHOD FOR OPERATING AN ELEVATOR INSTALLATION, PASSENGER GUIDING SYSTEM FOR AN ELEVATOR INSTALLATION AND ELEVATOR INSTALLATION

(71) Applicant: Inventio AG, Hergiswil (CH)

(72) Inventor: Edward Nowel, Columbia, NJ (US)

(21) Appl. No.: 18/252,372

(22) PCT Filed: Nov. 17, 2021
(86) PCT No.: PCT/EP2021/082002

§ 371 Date: May 10, 2023

Related U.S. Application Data
(60) Provisional application No. 63/114,655, filed on Nov. 17, 2020.

(51) Int. Cl. B66B 3/00; B66B 1/46; B66B 1/06

(52) U.S. Cl. CPC B66B 3/006; B66B 1/468; B66B 1/06; B66B 1/467; B66B 2201/4615; B66B 2201/103; B66B 2201/214; B66B 2201/212; B66B 2201/222; B66B 2201/223; B66B 2201/463; B66B 2201/4638; B66B 2201/4653

(57) ABSTRACT

A method for operating an elevator installation includes receiving a destination call of a passenger at a control unit and selecting an elevator car from a set of available elevator cars for transporting the passenger. The elevator car is selected such that elevator car spacing rules are observed. The method further includes determining an arrival time of the selected elevator car at the boarding floor, and determining a first arrival time of the passenger at an elevator landing corresponding to the selected elevator car on the boarding floor. The method includes directing, under the proviso that the first arrival time of the passenger at the elevator landing precedes the arrival time of the selected elevator car by a defined margin, the passenger to a waiting zone of a set of available waiting zones. The waiting zone is selected such that waiting zone spacing rules are observed.

### FIELD

Embodiments described herein generally relate to elevator installations and methods for operating elevator installations. More particularly, embodiments described herein relate to methods for operating elevator installations and passenger guiding systems, particularly for guiding passengers to maintain social distancing while using an elevator installation.

### BACKGROUND

Elevator installations are known as an effective means for quickly transporting passengers between floors or levels. Generally, elevators are expected to operate as efficiently as possible, i.e. offer transport for the highest possible number of passengers with the lowest number of trips, while simultaneously reducing the individual passenger wait time. Recent advances have therefore led to improved methods for scheduling optimal transport routes for elevator installations. One such advance is the use of a destination call control system, which provides improved efficiency compared to a conventional up/down control system. Such destination call control systems, for example, are provided by Schindler, including the SchindlerID® and PORT Technology systems. Further improvements can be had by purposefully allocating spaces or zones inside the elevator car to passengers, as is described in WO 2016/146357 A1.

While efficiency is typically one key aspect of an elevator installation, another important aspect to be considered is passenger safety. During times of increased infection risk, such as during a flu epidemic or a pandemic such as the COVID 19 pandemic, one important measure for maintaining passenger health can be the observance of adequate spacing between passengers, also known as social distancing. Social distancing can significantly reduce the risk of any uninfected person coming into physical contact with an infected person, thereby suppressing disease transmission, and can be effective when the infectious disease spreads via direct or indirect physical contact, droplet contact or airborne transmission.

However, implementing social distancing can be challenging in the context of an elevator installation, since traditionally, passenger crowding is known to occur at elevator landings, particularly in building lobbies, as well as within the elevator car. Because the available space inside an elevator car is typically limited, introducing social distancing rules often involves a tradeoff between safety and efficiency, and it can be challenging to provide an elevator installation that offers both at an adequate cost. In addition, if passengers perceive such safety measures as cumbersome or a waste of time, the general acceptance of the measures and adherence to set rules might be low.

### SUMMARY

There is therefore a need for a technology that provides an efficient way for operating an elevator installation, while at the same time implementing social distancing rules to maintain adequate spacing between passengers to reduce the risk of transmitting an infection while using the elevator installation.

In light of the above, according to an aspect, a method for operating an elevator installation is provided. The method includes receiving a destination call of a passenger at a control unit. The destination call defines a trip from a boarding floor to a destination floor. The method further includes selecting an elevator car from a set of available elevator cars for transporting the passenger. The elevator car is selected such that elevator car spacing rules are observed. The method further includes determining an arrival time of the selected elevator car at the boarding floor, and a arrival time of the passenger at an elevator landing corresponding to the selected elevator car on the boarding floor. The method further includes directing, under the proviso that the arrival time of the passenger at the elevator landing precedes the arrival time of the selected elevator car by a defined margin, the passenger to a waiting zone of a set of available waiting zones. The waiting zone is selected such that waiting zone spacing rules are observed. The method further includes moving the selected elevator car to the boarding floor, and directing the passenger to the elevator landing for transporting the passenger from the boarding floor to the destination floor in the selected elevator car.

According to an aspect, a passenger guiding system for an elevator installation is provided. The elevator installation includes a set of elevator cars. The passenger guiding system includes a user interface unit for receiving a destination call of a passenger. The destination call defines a trip from a boarding floor to a destination floor. The passenger guiding system further includes a control unit configured for designating a selected elevator car from the set of elevator cars to transport the passenger such that elevator car spacing rules are observed, and for calling the selected elevator car to a boarding floor or to a destination floor. The passenger guiding system further includes a passenger direction unit defining a set of waiting zones. The passenger direction unit is configured for determining an arrival time of the selected elevator car at the boarding floor, and an arrival time of the passenger at an elevator landing corresponding to the selected elevator car on the boarding floor. The passenger direction unit is configured for directing, under the proviso that the arrival time of the passenger at the elevator landing precedes the arrival time of the selected elevator car by a defined margin, the passenger to a waiting zone of the set of waiting zones. The waiting zone is selected such that waiting zone spacing rules are observed. The passenger direction unit is configured for directing, when the arrival time of the passenger at the elevator landing does not precede the arrival time of the selected elevator car by the defined margin, the passenger to the elevator landing.

According to an aspect, an elevator installation comprising a passenger guiding system according to an embodiment described herein is provided.

To briefly illustrate the shortcomings of known elevator installations, in a typical exemplary scenario, passengers who intend to use an elevator installation can enter a building at quasi-random times and with different destination floors. If social distancing rules are mandated, the passengers might queue up with adequate spacing and limit the occupancy of the individual elevator cars. This approach is only feasible for a small number of passengers and might quickly nullify any potential benefits of increased passenger spacing by resulting in longer interaction times between passengers while the passengers are waiting in the queue.

In another exemplary scenario of a known elevator installation, if a destination call control system is available, passengers might enter their destination at a terminal and then spread out in the building lobby as to maintain social distancing while they wait for the elevator car, which might be operated at reduced capacity. Thus, a significant risk of propagating a potential infection remains, particularly when the passengers cross paths while entering or exiting the elevator car, while waiting at random locations, and while moving from a waiting area to an elevator car. This risk typically increases with the number of passengers.

Embodiments of the present disclosure overcome these problems by directing the passengers to wait in dedicated waiting areas, and by assigning the passengers to elevator cars, such that minimal interaction between passengers occurs, and adequate spacing is maintained at all times. Thus, the risk of transmitting an infection between passengers is reduced, while the efficiency of the elevator installation can be maintained at a reasonable level. Additionally, the above benefits can be maintained independently of passenger load, such that the risk of transmitting an infection remains low, even if the elevator installation is operated at high capacity.

### DESCRIPTION OF THE DRAWINGS

The novel features and method steps characteristic of the improved technology, as well as other features and advantages thereof, are best understood by reference to the detailed description, which follows, when read in conjunction with the accompanying drawings, wherein:

FIG. 1 shows an exemplary flowchart illustrating one embodiment of a method for operating an elevator installation;

FIG. 2a shows a schematic illustration of an elevator installation in a first state according to an embodiment described herein;

FIG. 2b shows a schematic illustration of an elevator installation in a second state according to an embodiment described herein; and

FIG. 3 shows a schematic illustration of an elevator installation in which the improved technology is implemented.

### DETAILED DESCRIPTION

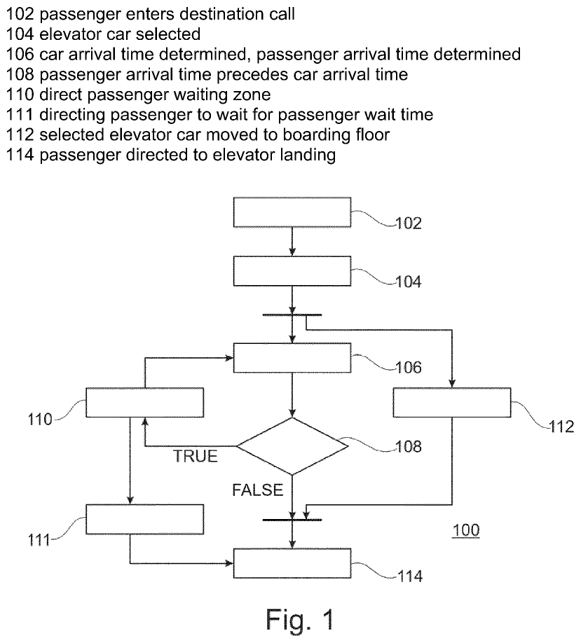

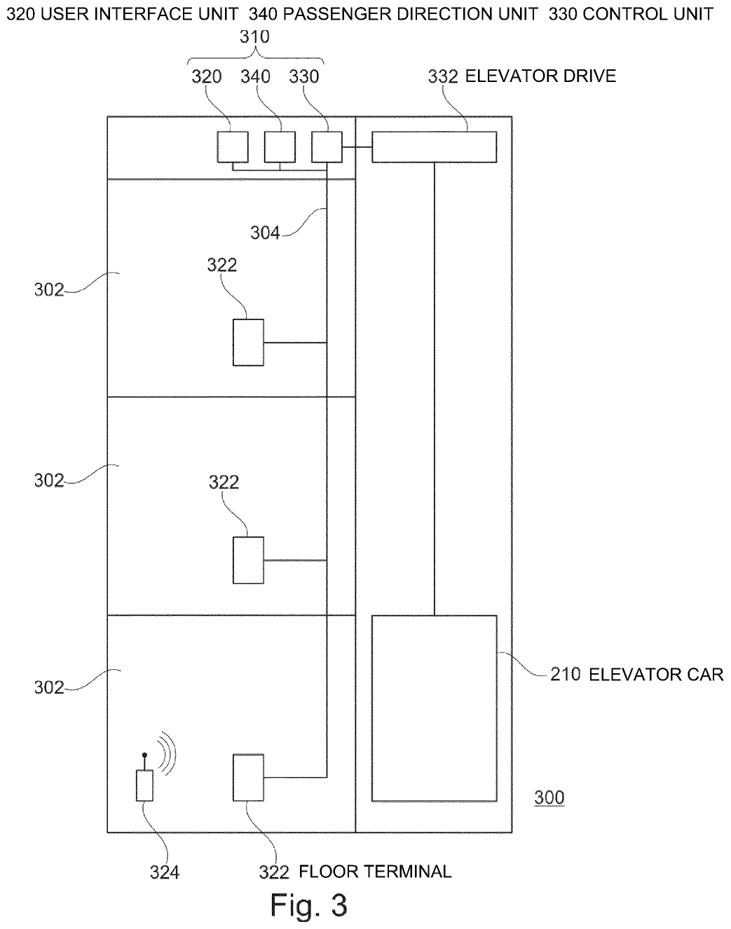

Referring now to FIG. 1, according to an embodiment, a method 100 for operating an elevator installation is described. At operation 102, a passenger enters a destination call defining a trip from a boarding floor to a destination floor. The boarding floor can be the current floor of the passenger, or a floor on which the passenger intends to board an elevator car at a future time. The destination call can be entered at a terminal, such as a floor terminal or a mobile terminal. The destination call can be transmitted to and received by a control unit. The control unit can be a control unit of the elevator installation, such as a passenger guiding system or a component of a passenger guiding system, particularly the passenger guiding system 310 described in further detail below in relation to FIG. 3. The control unit can be configured for operating at least one elevator car within the elevator installation.

As shown in FIG. 1, according to embodiments, at operation 104 an elevator car is selected from a set of available elevator cars for transporting the passenger. The set of available elevator cars might be a number of available elevator cars within the elevator installation, such as a number of available elevator cars in different elevator shafts. Additionally or instead, the set of available elevator cars might be a temporal map of available trips of one single elevator car, such as a transport schedule. Consequently, a single elevator car may comprise a set of available elevator cars, where each trip between two floors can be seen as a separate elevator car. The elevator car is selected such that elevator car spacing rules are observed. Selecting an elevator car can be understood as planning a trip for the passenger in an elevator car of the elevator installation.

According to embodiments, which can be combined with embodiments described herein, elevator car spacing rules are provided. Elevator car spacing rules can apply to passengers while traveling in the elevator car, particularly from the time after entering the elevator car up to the moment of exiting the elevator car. Elevator car spacing rules can be rules which are communicated to the passenger, or which are required to be followed by the passenger. Elevator car spacing rules can further be rules which are observed while assigning passengers to the elevator car. Elevator car spacing rules can also be rules which are unknown to the passenger and applied e.g. by the elevator installation and/or included in a method for operating an elevator installation. Elevator car spacing rules can be rules which assign positions, e.g. positions within elevator car zones, which are described in further detail below, to passengers within the elevator car. Elevator car spacing rules can involve rules or a combination of rules to prevent the spread of an infection between the passenger and another passenger. Elevator car spacing rules can enforce a minimum distance between passengers, i.e. passengers, groups of passengers or combinations thereof. In one example, elevator car spacing rules can enforce a minimum distance of 3 feet, 2 meters, 1.5 meters, 1 meter or an arbitrary unit chosen by a governing body, such as the approximate length of a baby elephant, between passengers or groups of passengers (e.g., between waiting zones and/or between elevator car zones). In one example, elevator car spacing rules can enforce a minimum floor area per passenger, such as at least 1 m², 1.5 m², 2 m², 3 m², 5 m² or at least 10 square feet. In one example, elevator car spacing rules can be independently set for each elevator car zone, such that a maximum number of passengers for each elevator car zone is defined, such as 1 passenger, 2 passengers, 3-5 passengers or even a higher discrete number of passengers. Elevator car spacing rules can also, e.g. if one elevator car has a single elevator car zone, be a representation of a maximum number of passengers for a specific elevator car, such as a maximum of 1 passenger for a small elevator car, or a maximum number of 4 passengers for a medium-sized elevator car.

As shown in FIG. 1, according to embodiments, after operation 104, the flowchart is branched, i.e. the following operations 106 and 112 happen in parallel. At operation 112, the selected elevator car is moved to the boarding floor. Moving the selected elevator car to the boarding floor should be understood as including the physical act of moving the elevator car in position such that it is ready to be accessed by the passenger on the boarding floor, and may include additional steps, such as opening the elevator car doors, allowing time for other passengers to exit, or such. The operation 112 does not require to be started immediately, particularly when other operations need to be performed first, such as finishing an ongoing transfer of other passengers to a different floor. The operation 112 can include adding the operation 112 to an operation queue, e.g. in the control unit, e.g. as a series of tasks to be executed for the selected elevator car.

As shown in FIG. 1, according to embodiments, at operation 106, an arrival time of the selected elevator car at the boarding floor is determined. The arrival time of the elevator car at the boarding floor is to be understood as the moment at which operation 112 is completed. As described above for operation 112, the arrival time can be variable depending on the state of the selected elevator car and/or the number of tasks still to be executed for the selected elevator car. The arrival time can be estimated, e.g. by adding the average time required for each task still to be executed for the selected elevator car, as described previously for operation 112.

As shown in FIG. 1, according to embodiments, at operation 106, an arrival time of the passenger at the elevator landing corresponding to the selected elevator car is determined. The arrival time of the passenger can be estimated. The estimation can be based on the typical walking speed of a passenger. The arrival time can be estimated by utilizing passenger profiles, e.g. known or recorded walking times of particular passengers, which can be stored in a database. The arrival time can be estimated based on statements made by the passenger, e.g. while making the destination call. The passenger can make statements including a planned arrival time, or statements from which an influence on the arrival time can be concluded, such as planned detours. For making the estimation, a location of the passenger, particularly the location of the passenger when making the destination call, can be utilized. For example, the destination call can be made at a defined location, e.g. if it has been entered at a fixed floor terminal with a known location, and the destination call can include the location of the terminal, or an information from which the location of the terminal can be derived. The destination call can be made at a mobile terminal, such as a smartphone, and the mobile terminal can, e.g. by utilizing GPS, the signals of a low energy beacons in the vicinity of the elevator installation, or such, include the position of the mobile terminal at the time of making the destination call in the destination call.

As shown in FIG. 1, according to embodiments, at decision 108, it is decided if the arrival time of the passenger at the elevator landing corresponding to the selected elevator car, which can be a first arrival time, precedes the arrival of the selected elevator car (“car arrival time”) at the elevator landing, i.e. the boarding floor, particularly for transporting the passenger from the boarding floor to the destination floor. The decision can be made under the assumption that either of the passenger's first arrival time or the car arrival time are somewhat inaccurate, i.e. comprise an error margin or lie within a confidence interval. The decision can be made by comparing the first arrival time and the car arrival time. The decision includes determining if the arrival time precedes the car arrival time by a defined margin. The defined margin can be set such that inaccuracies in the first arrival time and the car arrival times are considered when making the decision. The defined margin can be 0. The defined margin can be lenient and allow the passenger's arrival time to be before the car arrival time by a short period, such as 10 s, 5 s, 3 s or 1 s. A lenient defined margin can improve the efficiency of the elevator installation, by increasing the chance of having passengers ready to board the elevator car at the moment the elevator car arrives at the boarding floor. The defined margin can be strict and decide that the passenger's arrival time precedes the car arrival time even if the estimated first passenger arrival time lies after the car arrival time by a short period, such as 10 s, 5 s, 3 s or 1 s. A strict defined margin can reduce the chance that passengers interact at the elevator landing, e.g. when other passengers exit the elevator car on the boarding floor and move past the waiting passengers. The defined margin can be variable. The defined margin can be adjusted, such as dynamically adjusted, e.g. based on observed or anticipated passenger load, general infection risk, occupancy of the elevator car at the moment of arrival, or such. If at decision 108, it was decided that the passenger's arrival time precedes the arrival time of the selected elevator car by the defined margin, the result of decision 108 is TRUE and operation 110 will be executed. If at decision 108, it was decided that the passenger's arrival time does not precede the arrival time of the selected elevator car by the defined margin, the result of decision 108 is FALSE and operation 114 will be executed.

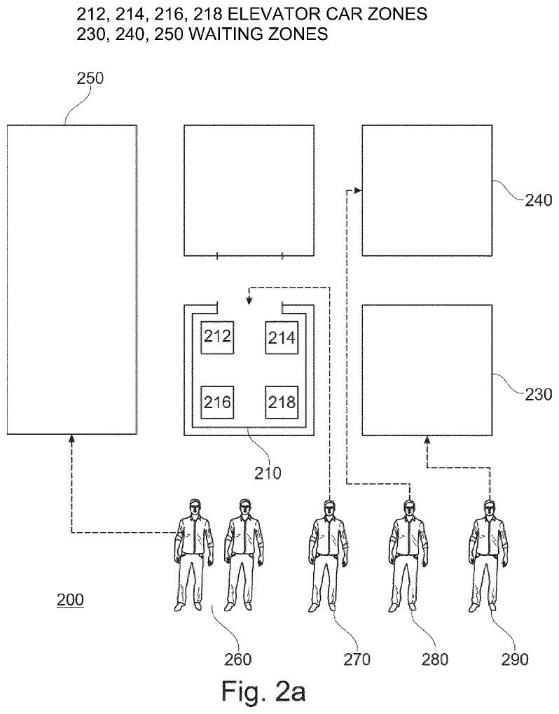

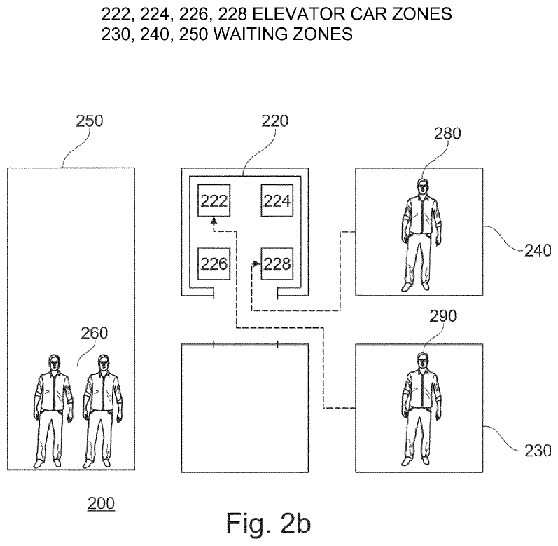

As shown in FIG. 1, according to embodiments, at operation 110, the passenger is directed to a waiting zone of a set of available waiting zones. Directing the passenger to a waiting zone can include communicating to the passenger the selected waiting zone, e.g. via a terminal, particularly during or after having made the call. Directing the passenger to a waiting zone can include the passenger moving to the waiting zone. The set of waiting zones can be a set of waiting zones as described in further detail below in relation to FIGS. 2a and 2b. The selected waiting zone is chosen such that waiting zone spacing rules are observed. The selected waiting zone can be selected such that passenger comfort is considered, and/or such that passenger have a comfortable travel experience. The waiting zone can be selected such that the trip from the location of making the destination call to the waiting zone is short. The waiting zone can be selected such that interaction between passengers on the way to the waiting zone is minimized. If a number of suitable waiting zones is available, the waiting zone can further be selected such that the zone is chosen according to passenger needs. In one example, if several suitable waiting zones are available, the waiting zone with the best amenities can be chosen, e.g. a zone with more comfortable seating arrangements or such. Selecting a waiting zone from the set of available waiting zones can involve a scoring algorithm, which selects the waiting zones according to the set of waiting zone spacing rules and expected passenger comfort, e.g. by making a preselection according to waiting zone spacing rules, and a second selection on the preselection according to a set of rules to improve passenger experience. The set of available waiting zones can be dynamically adjusted based on passenger load. In one example, the set of available waiting zones can include a number of “spillover” waiting zones, which can be selected mainly during times of high passenger load. By offering a good passenger experience, the acceptance of waiting zone spacing rules can be improved.

According to embodiments, which can be combined with embodiments described herein, waiting zone spacing rules are provided. Waiting zone spacing rules can be similar or identical to the elevator car spacing rules outlined above. Waiting zone spacing rules can apply to passengers while waiting in one or several waiting zones, particularly from the time the passenger is directed to the waiting zone to the time the passenger is directed to the elevator landing for transporting the passenger to the destination floor in the selected elevator car. Waiting zone spacing rules can be rules which are communicated to the passenger, or which are required to be followed by the passenger. Waiting zone spacing rules can further be rules which are observed while assigning passengers to a waiting zone. Waiting zone spacing rules can also be rules which are unknown to the passenger and applied e.g. by the elevator installation and/or included in a method for operating an elevator installation. Waiting zone spacing rules can be rules which assign positions to the passenger, e.g. positions within a waiting zone, or which assign waiting zones to a passenger, e.g. waiting zones from a set of available waiting zones. Waiting zone spacing rules can involve rules or a combination of rules to prevent the spread of an infection between the passenger and another passenger. Waiting zone spacing rules can enforce a minimum distance between passengers, i.e. passengers, groups of passengers or combinations thereof. In one example, waiting zone spacing rules can enforce a minimum distance of 3 feet, 2 meters, 1.5 meters, 1 meter or an arbitrary unit chosen by a governing body, between passengers or groups of passengers within the zone. In one example, waiting zone spacing rules can enforce a minimum floor area per passenger, such as at least 1 m², 1.5 m², 2 m², 3 m², 5 m² or at least 10 square feet. In one example, waiting zone spacing rules can be independently set for each waiting zone, such that a maximum number of passengers for each waiting zone is defined, such as 1 passenger, 2 passengers, 3-5 passengers or even a higher discrete number of passengers. Waiting zone spacing rules can also be a representation of a maximum number of passengers for a specific waiting zone. The maximum number of passengers for a specific waiting zone can be chosen based on the shape or size of the waiting zone, such as a maximum of 1 passenger for a small waiting zone, or a maximum number of 4 passengers for e.g. an oblong or larger waiting zone.

According to embodiments, which can be combined with embodiments described herein, waiting zone spacing rules can further include only assigning a waiting zone to a passenger when the waiting zone is empty. The maximum number of passengers per waiting zone can be set to 0 for zones which are not to be used, can be 1 for waiting zones which should only be occupied by one passenger, or if the passenger load is low, such that a full waiting zone is available for each passenger. The number of passengers for a waiting zones can be also be set to arbitrary numbers, such as 2 passengers, 3 passengers, 5 passengers, 10 passengers or such, provided that the waiting zone spacing rules as described above are observed.

According to embodiments, which can be combined with embodiments described herein, elevator car spacing rules and/or waiting zone spacing rules can, in some cases, be dynamically adapted to the current situation, e.g. the estimated infection risk for each passenger. In one example, if the risk for spreading an infection is low because the epidemiological incidence is low, a higher number of passengers per elevator car and/or waiting zone can be allowed.

According to embodiments, which can be combined with embodiments described herein, elevator car spacing rules and/or waiting zone spacing rules can further include rules to not exceed a maximum contact time between passengers, particularly between passengers waiting together in a waiting zone or travelling together in an elevator car. The maximum contact time can be 1 minute, 2 minutes, 5 minutes, or 10 minutes.

According to embodiments, which can be combined with embodiments described herein, elevator car spacing rules and/or waiting zone spacing rules can further include rules to not exceed a maximum number of passengers without personal protective equipment in waiting together in a waiting zone or travelling together in an elevator car. Personal protective equipment can be a clothing such as facemask, gloves, skin protection or such.

According to embodiments, which can be combined with embodiments described herein, elevator car spacing rules and/or waiting zone spacing rules can further include rules to minimize the chance of spreading an infection between groups of passengers. Elevator car spacing rules and/or waiting zone spacing rules can include rules to not have groups of passengers exceeding a passenger count of n passengers interact with another passenger or another group of passengers exceeding a count of m passengers, where n and/or m can be a number from 1 to 10, such as 2 or 3.

According to embodiments, which can be combined with embodiments described herein, the passenger, e.g. after having been directed to a waiting zone at operation 110, arrives at the waiting zone and waits in the waiting zone for a passenger wait time. The passenger can be instructed to wait for a passenger wait time. Instructing the passenger to wait for a passenger wait time can include communicating, to the passenger, the passenger wait time, e.g. via a terminal, particularly during or after having made the call. The passenger wait time can be a timepoint up to which the passenger waits in the waiting zone. The passenger wait time can include the time required for the passenger to move to the waiting zone.

According to embodiments, which can be combined with embodiments described herein, the passenger, e.g. after having been directed to a waiting zone at operation 110, will not arrive at the elevator landing at the first arrival time. Instead, the passenger will be instructed to wait in the waiting zone for a passenger wait time. The passenger, after having been directed to wait in the waiting zone for the passenger wait time, can have a second arrival time. The second arrival time can be determined by the passenger wait time and the transfer time of the passenger from the waiting zone to the elevator landing.

As shown in FIG. 1, according to embodiments, after operation 110, operation 106 can be performed again. For as long as the second passenger arrival time precedes the car arrival time, according to the following decision 108 and operations 110 and 106, the passenger will be directed to wait in the waiting zone. If in operation 108 it is decided that the second arrival time determined at operation 106 does not precede the car arrival time, then operation 114 is performed. An advantage of performing operation 106 again, particularly periodically, such as in a loop, is the possibility of the method to more accurately determine the moment at which operation 114 is to be performed. Particularly, any unexpected delays or influences on the car arrival time can be taken into account and considered in the decision of operation 108.

As shown in FIG. 1, according to embodiments, at operation 114 the passenger is directed to the elevator landing for transporting the passenger from the boarding floor to the destination floor in the selected elevator car. In one embodiment, the passenger is directed after the result of decision 108 has been received. The direction can be communicated to the passenger. The communication can include the display of a passenger identifier, e.g. on a floor terminal or a display close to or within the waiting zone. The communication can include displaying a message on a mobile terminal accessible by the passenger. The communication can include an audio signal broadcast, such as a call to enter the elevator car. Further ways for calling a passenger are known in the art and can be equally suitable. After having received the call, the passenger typically moves to the elevator landing and can, without any significant waiting time in the vicinity of the elevator landing, enter the elevator car, which typically should arrive at the same time.

As shown in FIG. 1, according to embodiments, which can be combined with embodiments described herein, after operation 110, the operation 106 can be omitted, and operation 111 can be performed instead. Instead of again checking, at operation 106, if the second arrival time precedes the car arrival time, a required wait time in the waiting zone for the passenger to arrive at the second arrival time within a predefined margin of the car arrival time can be pre-determined, and the customer can be directed to wait in the waiting zone for the pre-determined passenger wait time. Operation 111 includes directing the passenger to wait for the passenger wait time. The passenger wait time can be a time required for the passenger to wait such that, after expiry of the passenger wait time, the passenger can move from the waiting zone to the elevator landing, and arrives together with the selected elevator car at the elevator landing. In the described embodiment, operation 114, in which the passenger is directed to the elevator landing, can thus be given in advance. The direction can be given together with the direction of operation 110, in which the passenger is directed to a waiting zone. The direction can include the direction to move to a waiting zone, and to wait in the waiting zone until the passenger wait time has expired. According to this embodiment, no further communication to the passenger is required after having communicated, to the passenger, the passenger wait time, e.g. via a terminal, particularly shortly after having made the call. Additionally or instead, the passenger may be called as described above in operation 114.

According to embodiments, which can be combined with embodiments described herein, the transfer time of the passenger from the waiting zone to the elevator landing is determined after the arrival of the passenger at the waiting zone. According to an embodiment, the transfer time of the passenger to the waiting zone can be used to more accurately estimate the future transfer time of the passenger from the waiting zone to the elevator landing. The future transfer time from the waiting zone to the elevator landing can be used to more accurately calculate the required passenger wait time. The embodiment can include receiving the arrival time of the passenger at the waiting zone. The arrival time can be determined by monitoring the waiting zone with a sensor. The arrival time can be determined by requesting and/or receiving a passenger position from the mobile terminal device when the passenger arrives at the waiting zone.

Referring now to FIGS. 2a and 2b, according to an embodiment, two states of an exemplary elevator installation 200 on a boarding floor are shown to help better understand the technology. The elevator installation 200 can be configured for implementing the method 100, such as the method shown in FIG. 1. The elevator installation 200 can be a schematic representation of an elevator installation, e.g. in a building lobby. The elevator installation includes two elevator cars 210, 220 in two separate elevator shafts. In FIG. 2a, the elevator car 210 is present on the boarding floor, while elevator car 220 is on a different floor. In FIG. 2b, elevator car 220 is present on the boarding floor. According to embodiments, a different number of elevators can be implemented, such as 1 elevator, 3-5 elevators, particularly 6 elevators.

As shown in FIGS. 2a and 2b, according to embodiments, the elevator installation 200 includes waiting zones 230, 240 and 250. In the embodiment 200, waiting zones 230 and 240 are small waiting zones, and waiting zone 250 is a large waiting zone. The waiting zones are arranged such that the transmission of an infection between passengers in different waiting zones is prevented. The waiting zones can be spread out over an adequate distance. The waiting zones can include separators, such as walls or partitions, between the zones. The waiting zones can be separate rooms. According to embodiments, a different number of waiting zones can be implemented, such as 2 waiting zones, 4 waiting zones, or 5-10 waiting zones.

As shown in FIGS. 2a and 2b, according to embodiments, the elevator cars 210, 220 of the elevator installation 200 include elevator car zones 212, 214, 216, 218 and 222, 224, 226, 228. The elevator car zones can be set up to implement, allow or facilitate the observance of elevator car spacing rules. The elevator car spacing rules can be elevator car spacing rules as described above.

According to embodiments, which can be combined with other embodiments described herein, elevator car spacing zones can be zones within the elevator car to be occupied by passengers. Particularly, elevator car spacing zones can be parts of the elevator car floor on which the passengers should stand during transport in the elevator car. Elevator car zones can be set up such that boarding of the elevator car is more ordered, such that, e.g. passengers which are traveling to destination floors travel that require a longer travel time are assigned to elevator car zones in the back of the elevator car. Elevator car spacing rules can be implemented by requiring passengers to occupy particular elevator car zones. In the example of FIGS. 2a and 2b, four elevator car zones are available for each elevator car, with the 4 zones each corresponding to a corner of the elevator car. Different arrangements of elevator car zones can be feasible for differently sized elevator cars, such as, but not limited to, two zones for oblong, narrow elevator cars, or six zones in a 2×3 arrangement in a larger elevator car.

As shown in FIG. 2a, in the given example, passengers 260, 270, 280 and 290 have just requested transport from the elevator installation and each entered a destination call. Passenger 260 is a group of 2 passengers travelling to the same destination floor, the other passengers travel alone to different destination floors, with passenger 270 traveling to floor a, and passengers 280 and 290 travelling to floor b. For passenger 270, it has been determined that elevator car 210 should be used. Elevator car 210 is waiting on the boarding floor. Since the passenger arrival time of passenger 270 is after the car arrival time, passenger 270 is immediately directed to the car 210. Since passenger 270 is traveling alone, no elevator car zone is assigned and no further elevator car spacing rules need to be observed.

As shown in FIG. 2a, in the given example, passenger 280 is directed to waiting zone 240 and passenger 290 is directed to waiting zone 230. The group of passengers 260 is directed to waiting zone 250. In the embodiment, care is taken to avoid passengers crossing paths on the way to the waiting zones. The waiting zones are assigned according to waiting zone spacing rules, which can be the waiting zone spacing rules as described above. Accordingly, even though the passengers 280 and 290 are travelling to the same destination floor, they are directed to separate waiting zones. Accordingly, the larger waiting zone 250 is assigned to the group of passengers 260 to provide for the more available spacing between the members of the group.

As shown in FIG. 2b, a state following the state shown in FIG. 2a can be seen. Here, passenger 270 has left the boarding floor in elevator car 210 (not shown) and passengers 260, 280 and 290 have been waiting in their respective waiting zones 250, 240, 230. Elevator car 220 has just arrived on the boarding floor and passengers 280 and 290 have been directed, as is symbolized by the dotted lines, to move to the landing corresponding to elevator car 220 for boarding the elevator car 220. The passengers 280 and 290 have been assigned elevator car zones 222 and 228 according to elevator car spacing rules intended to enforce a minimum distance between passengers 280 and 290. The elevator car spacing rules can be elevator car spacing rules as described above. In the embodiment, care is taken that passengers 280 and 290 have minimum interaction on the way to the elevator landing or in front of the elevator landing, by directing the passengers such that they both first meet when entering the elevator car. After having entered the elevator car 220, passengers 280 and 290 will arrive at their destination floor shortly thereafter, having only spent a limited time together and always having observed a minimum distance to each other. Passengers 280 and 290 will not have interacted with passengers 260 and 270, and passengers 260 and 270 will not have interacted with any other passengers. The group of passengers 260 will be assigned to an available elevator car shortly. Thus, in the shown example, elevator installation 200 can effectively provide transport to all passengers, while maintaining social distancing according to a set of elevator car spacing rules and waiting zone spacing rules which have been discussed earlier.

Referring now to FIG. 3, according to an embodiment, an elevator installation 300 is shown schematically in a side view. The elevator installation 300 can be configured for implementing the method 100, such as the method shown in FIG. 1. The elevator installation can, according to some aspects, be the elevator installation 200, such as the elevator installation shown in FIG. 2a or FIG. 2b. The elevator installation includes at least one elevator car driven by an elevator drive 332 between levels 302 inside a structure, such as a building.

As shown in FIG. 3, according to embodiments, the elevator installation 300 includes a passenger guiding system 310. The passenger guiding system 310 includes a user interface unit 320, a control unit 330 and a passenger direction unit 340. The components of the passenger guiding system 310 are coupled via communication bus 304. The communication bus 304 communicatively couples the components of the passenger guiding system 310 such that the components of the passenger guiding system 310 can communicate and/or exchange information, such as guiding signals, directions or the likes.

According to embodiments, which can be combined with embodiments described herein, the passenger guiding system 310 can be a set of communicatively coupled modules. The passenger guiding system 310 can comprise a number of hardware modules, or a single hardware module, such as a controller module and/or a computer, and the modules of the passenger guiding system can be implemented in the form of software, e.g. as programs. The passenger guiding system can include further modules, such as an elevator controller, and/or be communicatively coupled to further elements of the elevator installation, such as the elevator controller. The elevator controller can be comprised within the same single hardware module as the passenger guiding system. The elevator controller can be comprised within the control unit 330.

According to embodiments, which can be combined with embodiments described herein, the elevator installation 300 can comprise an elevator drive 332 for moving the elevator car between floors. The elevator drive 332 can be communicatively coupled to e.g. the elevator controller to receive control messages from the elevator controller, and/or to send status messages to the elevator controller. The elevator controller can control the elevator drive, thereby controlling the movement of the elevator car within the elevator installation.

According to embodiments, which can be combined with embodiments described herein, the user interface unit 320 is configured for receiving a destination call of a passenger. The destination call defines a trip from a boarding floor to a destination floor. The user interface unit 320 can be configured for transmitting the destination call to the control unit 330. The use interface unit 320 can comprise one or more terminals for receiving the user input, such as floor terminals 322 or mobile terminal 324. The terminals 322, 324 can be communicatively coupled to the user interface unit 320, i.e. further components comprising the user interface unit 320, e.g. by a communication bus 304, or by a wireless transmitter/receiver. The user interface unit 320 can be communicatively coupled to the passenger direction unit 340 for displaying directive instructions to a passenger. The user interface unit 320 can include one or more display units communicatively coupled to the passenger direction unit 340, particularly for displaying directive instructions to the passenger. The display unit can be included in a floor terminal 322 or a mobile terminal 324. The display unit can be a display within a waiting zone. The display unit can be a projector device. The display unit can include visual and/or non-visual means for communicating instructions to the passengers, such as loudspeakers for broadcasting audible instructions.

According to embodiments, which can be combined with embodiments described herein, the control unit 330 can be configured for receiving, from the user interface unit 320, the destination call. The control unit 330 is further configured for designating a selected elevator car from the set of elevator cars to transport the passenger such that elevator car spacing rules are observed, and for calling the selected elevator car to a boarding floor or to a destination floor. The elevator car spacing rules can be the elevator car spacing rules according to an embodiment described herein. Calling the selected elevator car can result in the selected elevator car to be controlled, e.g. by the elevator controller, to physically perform the trip from the boarding floor to the destination floor. The control unit 330 can be configured for transmitting status information to the passenger direction unit 340, particularly status information from which a car arrival time of the elevator car 210 at the boarding floor, particularly for performing the trip from the boarding floor to the destination floor, can be deduced.

According to embodiments, which can be combined with embodiments described herein, the passenger direction unit 340 defines a set of waiting zones. The waiting zones can be waiting zones as described in further detail for elevator installation 200 in relation to FIGS. 2a and 2b. The passenger direction unit 340 is configured for determining an arrival time of the selected elevator car at the boarding floor, and an arrival time of the passenger at an elevator landing corresponding to the selected elevator car on the boarding floor. For this, information transmitted to the user direction unit 340 by the control unit 330 and the user interface unit 320 can be utilized.

According to embodiments, which can be combined with embodiments described herein, the passenger direction unit 340 is configured to direct, after having determined the arrival times and under the proviso that the arrival time of the passenger at the elevator landing precedes the arrival time of the selected elevator car by a defined margin, the passenger to a waiting zone of the set of waiting zones. The passenger direction unit 340 can be configured to direct the user to the elevator landing without first directing the user to a waiting zone, particularly when the elevator car arrival time is before the passenger arrival time at the elevator landing. Directing the passenger can be performed according to the method 100 described in relation with FIG. 1. The passenger guiding system 310 can be configured for directing the passenger by utilizing the user interface unit 320 as described above.

According to embodiments, which can be combined with embodiments described herein, the passenger direction unit 340 is configured to select the waiting zone such that waiting zone spacing rules are observed. The waiting zone spacing rules can be the waiting zone spacing rules according to an embodiment described herein.

According to embodiments, which can be combined with embodiments described herein, the passenger direction unit 340 is configured for directing, when the arrival time of the passenger at the elevator landing does not precede the arrival time of the selected elevator car by the defined margin, the passenger to the elevator landing. This condition can apply either after the passenger has been waiting in the waiting zone, or instantly after the passenger has made the destination call. The passenger guiding system 310 can be configured for directing the passenger by utilizing the user interface unit 320 as described above.

According to embodiments, which can be combined with embodiments described herein, the directions given to the passenger by the passenger direction unit 340 can include one or more of the following: directions to move to an elevator landing, directions to move to a waiting zone, directions to wait for a passenger wait time and/or directions to occupy an elevator car zone. Some or all of the directions can be communicated to the passenger by utilizing the user interface unit 320 as described above.

According to embodiments, which can be combined with embodiments described herein, the user interface unit 320 can be configured for receiving a destination call including a passenger location. The passenger direction unit 340 can be communicatively coupled to the user interface unit for receiving the passenger location. The passenger direction unit can be configured to determine the arrival time of the first passenger at the elevator landing, which can be an arrival time of a passenger at an elevator landing, such as a first arrival time as described above, by estimating a transfer time of the passenger from the passenger location to the elevator landing.

Next, general aspects of the technology will be discussed.

According to an aspect, the passenger direction unit is configured to synchronize the second arrival time to the arrival time of the selected elevator car by calculating a required passenger wait time from the arrival time of the selected elevator car and the estimated transfer time of the passenger from the waiting zone to the elevator landing.

According to an aspect, the destination call includes a passenger count, and the passenger is a group of passengers.

According to an aspect, an elevator installation comprising the passenger guiding system according to an embodiment as described herein is disclosed.

According to an aspect, the use of a passenger guiding system according to an embodiment as described herein in an elevator installation, particularly an elevator installation according to an embodiment as described herein, is disclosed.

Although some embodiments of the various methods disclosed herein are described as comprising a certain number of method acts, further embodiments of a given method can comprise more or fewer method acts than are explicitly disclosed herein. In additional embodiments, method acts are performed in an order other than as disclosed herein. In some cases, two or more method acts can be combined into one method act. In some cases, one method act can be divided into two or more method acts.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for operating an elevator installation, the method comprising the steps of:
receiving a destination call of a passenger at a control unit, wherein the destination call defines a trip from a boarding floor to a destination floor;
selecting an elevator car from a set of available elevator cars for transporting the passenger, wherein the selected elevator car is such that elevator car spacing rules that apply to passengers in the selected elevator car are observed;
determining an arrival time of the selected elevator car at the boarding floor, and determining an arrival time of the passenger at an elevator landing corresponding to the selected elevator car on the boarding floor;
directing, when the arrival time of the passenger at the elevator landing precedes the arrival time of the selected elevator car by a defined margin, the passenger to a waiting zone of a set of available waiting zones, wherein the waiting zone is selected such that waiting zone spacing rules that apply to passengers in the waiting zone are observed;
moving the selected elevator car to the boarding floor; and
directing the passenger to the elevator landing for transporting the passenger from the boarding floor to the destination floor in the selected elevator car.

17. The method according to claim 16 wherein the selected elevator car has a plurality of elevator car zones for passengers to occupy while traveling in the selected elevator car, and wherein the elevator car spacing rules include assigning passengers to the elevator car zones.

18. The method according to claim 16 wherein the destination call is made at a defined location, and wherein the arrival time of the passenger is determined by estimating a transfer time of the passenger from the location of the destination call to the elevator landing.

19. The method according to claim 16 wherein the arrival time of the passenger is a first arrival time, and including instructing the passenger to wait in the waiting zone for a passenger wait time until the arrival time of the selected elevator car and a second arrival time of the passenger at the elevator landing are within the defined margin, wherein the second arrival time is determined by the passenger wait time and a transfer time of the passenger from the waiting zone to the elevator landing.

20. The method according to claim 16 wherein at least one of the elevator car spacing rules or the waiting zone spacing rules prevents a spread of an infection between the passenger and another passenger.

21. The method according to claim 20 wherein the at least one rule enforces a minimum distance between a first passenger or first group of passengers and a second passenger or a second group of passengers.

22. The method according to claim 16 wherein at least one of the elevator car spacing rules or the waiting zone spacing rules forbids at least one of:
exceeding a maximum number of passengers per each of the waiting zones;
exceeding a maximum number of passengers per each of a plurality of elevator car zones;
falling below a minimum average distance between passengers;
falling below a minimum floor area per passenger;
exceeding a maximum contact time between passengers;
exceeding a maximum number of passengers without personal protective equipment; and
having groups of passengers exceeding a first passenger count interact with another passenger or another group of passengers exceeding a second count.

23. The method according to claim 16 wherein a transfer time of the passenger from the waiting zone to the elevator landing is determined after the arrival of the passenger at the waiting zone.

24. The method according to claim 16 wherein the waiting zones of the set of available waiting zones are arranged such that a transmission of an infection between passengers in different waiting zones is prevented.

25. The method according to claim 16 wherein the set of available waiting zones is dynamically adjusted based on passenger load.

26. The method according to claim 16 wherein directing the passenger to the elevator landing includes minimizing an interaction of the passenger with other passengers on the way to the elevator landing or in front of the elevator landing.

27. A passenger guiding system for an elevator installation, the elevator installation having a set of elevator cars, the passenger guiding system comprising:
a user interface unit adapted for receiving a destination call of a passenger, wherein the destination call defines a trip from a boarding floor to a destination floor in the elevator installation;
a control unit adapted for designating a selected elevator car from the set of elevator cars to transport the passenger such that elevator car spacing rules that apply to passengers in the selected elevator car are observed, and for calling the selected elevator car to the boarding floor;
a passenger direction unit defining a set of waiting zones;
wherein the passenger direction unit determines an arrival time of the selected elevator car at the boarding floor, and an arrival time of the passenger at an elevator landing corresponding to the selected elevator car on the boarding floor;
wherein the passenger direction unit directs, when the arrival time of the passenger at the elevator landing precedes the arrival time of the selected elevator car by a defined margin, the passenger to a selected waiting zone of the set of waiting zones, the waiting zone being selected such that waiting zone spacing rules are observed; and
wherein the passenger direction unit directs, when the arrival time of the passenger at the elevator landing does not precede the arrival time of the selected elevator car by the defined margin, the passenger to the elevator landing.

28. The passenger guiding system according to claim 27 wherein the user interface unit includes at least one of:
a floor terminal communicatively coupled to the user interface unit;
a mobile terminal device configured for wireless communication, wherein the mobile terminal device is communicatively coupled to the user interface unit; and
a display unit communicatively coupled to the passenger direction unit and adapted for displaying directive instructions to the passenger.

29. The passenger guiding system according to claim 27 wherein the passenger direction unit directs the passenger with at least one directive instruction to:
move to the elevator landing;
move to the selected waiting zone;
wait for a passenger wait time; and
occupy an elevator car zone in the selected elevator car

30. The passenger guiding system according to claim 27 wherein the destination call includes a passenger location of the passenger, wherein the passenger direction unit is communicatively coupled to the user interface unit for receiving the passenger location, and wherein the passenger direction unit determines the arrival time by estimating a transfer time of the passenger from the passenger location to the elevator landing.

31. An elevator installation comprising a set of elevator cars and the passenger guiding system according to claim 27 guiding passengers in the elevator installation.
